(19) United States
(12) Patent Application Publication
(10) Pub. No.: US 2025/0219961 A1
(43) Pub. Date: Jul. 3, 2025

(54) APPARATUS AND METHOD FOR CONTROLLING CLOUD MEDIA PRODUCTION

(71) Applicant: ELECTRONICS AND TELECOMMUNICATIONS RESEARCH INSTITUTE, Daejeon (KR)

(72) Inventors: Hye-Ju OH, Daejeon (KR); Soon-Choul KIM, Daejeon (KR); Jae-Young LEE, Daejeon (KR); Jae-Hyun SEO, Daejeon (KR)

(73) Assignee: ELECTRONICS AND TELECOMMUNICATIONS RESEARCH INSTITUTE, Daejeon (KR)

(21) Appl. No.: 18/983,609

(22) Filed: Dec. 17, 2024

(30) Foreign Application Priority Data
Dec. 28, 2023 (KR) 10-2023-0194365

(51) Int. Cl. H04L 47/76; H04L 65/61; H04L 65/80

(52) U.S. Cl. CPC H04L 47/76; H04L 65/61; H04L 65/80

(57) ABSTRACT

Disclosed herein are an apparatus and method for controlling cloud media production. The apparatus for controlling cloud media production may be configured to check an available network bandwidth for data transmission based on resource registration information obtained from a Registration and Discovery System (RDS), receive a transport file from a media sender and obtain parameter information related to transmission by the media sender, adjust a transmission parameter of the transport file based on the resource registration information and the parameter information, transmit the transport file, the transmission parameter of which is adjusted, to the media sender and the media receiver, and start media streaming in consideration of a response to the transport file, the transmission parameter of which is adjusted, from the media sender and the media receiver.

### CROSS REFERENCE TO RELATED APPLICATION

This application claims the benefit of Korean Patent Application No. 10-2023-0194365, filed Dec. 28, 2023, which is hereby incorporated by reference in its entirety into this application.

### BACKGROUND OF THE INVENTION

### 1. Technical Field

The present disclosure relates generally to media program production technology, and more particularly to technology for producing cloud-Internet Protocol (IP)-based high-quality media.

### 2. Description of the Related Art

Society of Motion Picture and Television Engineers (SMPTE) ST 2110 is a standard for transmitting uncompressed video and audio signals, and enables the use of IP connections for the flow and control of all media in media production facilities. As a result, program production systems using IP instead of the existing Serial Digital Interface (SDI) are taken into consideration, and are introduced to outdoor broadcasting (OB) vans and studios. The connectivity of IP networks allows for sharing work across multiple production setups, thus enabling connection to and operation of large-scale program production systems. Additionally, as the connectivity of IP networks have been expanded to and used in platforms using the cloud, flexible and remote production using software-based tools becomes possible, and thus advantages such as efficient resource utilization including equipment and personnel and cost-effectiveness including reduced on-site setup time may be utilized. In line with such networked media production and flows, Networked Media Open Specifications (NMOS) have been developed as standard technology for managing and controlling broadcast equipment, and have presented the outlines of flow control and registration of IP signals, aiming to support an open platform. The NMOS standard discloses a method for mutually detecting usable streams between devices, a method for setting a flow from a sender to a receiver, a method for managing network resources when a broadcast controller is required, etc. It is possible to perform search/registration and connection management between transmission devices using the NMOS standard. However, in a wide-area connection environment such as the cloud, when multiple devices may simultaneously attempt registration and connection or need to perform large-capacity media transmission, stable and efficient bandwidth utilization is required. Depending on the network situations, there may be a need to differently set the transmission methods as well as device registration and connection methods.

Multiple protocol specifications are used to reliably transmit compressed video over IP networks, and transmission characteristics vary depending on the transmission method. For instance, a segment where video captured by a camera is sent to a production station in the cloud is referred to as a contribution segment. In this segment, transmission protocols such as RTMP, SRT, RTP, and RIST are commonly used, wherein respective transmission protocols have different characteristics in terms of packet loss, jitter, latency, and bandwidth. Even in the case where large-capacity media transmission is required through remote large-scale node connections in a wide-area connectivity environment in which a network situation is changing, there is a need to differently set a compression transmission method and a connection method for capabilities of senders/receivers when connections of network nodes are established. In detail, network nodes need to be able to be efficiently and stably selected and used in large-scale connections.

Meanwhile, Korean Patent Application Publication No. 10-2022-0071535 entitled “Cloud-Based Media Content Creation and Customized Advertisement Provision System Using the Same, and Method Using the Same” discloses a system and method that can provide customized advertisements to content producers and customers while providing platforms in which media content can be created through real-time access based on a cloud and providing content in which various themes are fused.

### SUMMARY OF THE INVENTION

Accordingly, the present disclosure has been made keeping in mind the above problems occurring in the prior art, and an object of the present disclosure is to register a remote media device and control the connection thereof in a wide-area network environment so as to produce cloud-IP-based high-quality media.

Another object of the present disclosure is to transfer data from devices having various formats of personal and professional Audio/Video (A/V) devices as well as transmitting large-capacity media, and provide interoperation with media having various interface formats.

A further object of the present disclosure is to stably and efficiently transfer video data depending on variable network situations and resource states.

Yet another object of the present disclosure is to efficiently operate management of large-scale connections and separately set up resource connections or set up resource connections either individually or for respective groups, thus facilitating work scalability and management.

In accordance with an aspect of the present disclosure to accomplish the above objects, there is provided an apparatus for controlling cloud media production, including one or more processors, and memory configured to store at least one program that is executed by the one or more processors, wherein the at least one program is configured to check an available network bandwidth for data transmission based on resource registration information obtained from a Registration and Discovery System (RDS), receive a transport file from a media sender and obtain parameter information related to transmission by the media sender, adjust a transmission parameter of the transport file based on the resource registration information and the parameter information, transmit the transport file, the transmission parameter of which is adjusted, to the media sender and the media receiver, and start media streaming in consideration of a response to the transport file, the transmission parameter of which is adjusted, from the media sender and the media receiver.

The resource registration information may include capabilities and network protocols of the media sender and the media receiver.

The at least one program may be configured to determine parameters related to media transmission based on the capabilities of the media sender and the media receiver, a required bandwidth necessary for data transmission, and an available network bandwidth.

The at least one program may be configured to select a transmission buffer, a video quality, and a transmission protocol within the capabilities and constraints of the media sender and the media receiver depending on network status and waiting time.

The at least one program may be configured to determine a node connection method depending on network status of the media sender and the media receiver.

The at least one program may be configured to set up a simultaneous activation time and transmission parameters for devices related to at least two programs, and a group-wise simultaneous connection between the devices, based on the available network bandwidth.

The group-wise simultaneous connection may be performed such that, based on a program name of media corresponding to the resource registration information and an identifier of a station through which the media is to be transmitted, groups of the media sender and the media receiver are set.

In accordance with another aspect of the present disclosure to accomplish the above objects, there is provided a method for controlling cloud media production, the method being performed by an apparatus for controlling cloud media production, the method including checking an available network bandwidth for data transmission based on resource registration information obtained from a Registration and Discovery System (RDS), receiving a transport file from a media sender and obtain parameter information related to transmission by the media sender, adjusting a transmission parameter of the transport file based on the resource registration information and the parameter information, transmitting the transport file, the transmission parameter of which is adjusted, to the media sender and the media receiver, and starting media streaming in consideration of a response to the transport file, the transmission parameter of which is adjusted, from the media sender and the media receiver.

The resource registration information may include capabilities and network protocols of the media sender and the media receiver.

Adjusting the transmission parameter may include determining parameters related to media transmission based on the capabilities of the media sender and the media receiver, a required bandwidth necessary for data transmission, and an available network bandwidth.

Adjusting the transmission parameter may further include selecting a transmission buffer, a video quality, and a transmission protocol within the capabilities and constraints of the media sender and the media receiver depending on network status and waiting time.

Adjusting the transmission parameter may further include determining a node connection method depending on network status of the media sender and the media receiver.

Adjusting the transmission parameter may further include setting up a simultaneous activation time and transmission parameters for devices related to at least two programs, and a group-wise simultaneous connection between the devices, based on the available network bandwidth.

The group-wise simultaneous connection may be performed such that, based on a program name of media corresponding to the resource registration information and an identifier of a station through which the media is to be transmitted, groups of the media sender and the media receiver are set.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a cloud-IP media production platform according to an embodiment of the present disclosure;

FIG. 2 is a diagram illustrating in detail an example of the IP media gateway illustrated in FIG. 1;

FIG. 3 is a block diagram illustrating a cloud media production system according to an embodiment of the present disclosure;

FIG. 4 is a diagram illustrating multiple devices registered in an apparatus for controlling cloud media production according to an embodiment of the present disclosure;

FIG. 5 is a diagram illustrating a method for storing information about registered resources according to an embodiment of the present disclosure;

FIG. 6 is a sequence diagram illustrating a method for controlling cloud media production according to an embodiment of the present disclosure; and

FIG. 7 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present disclosure will be described in detail with reference to the attached drawings.

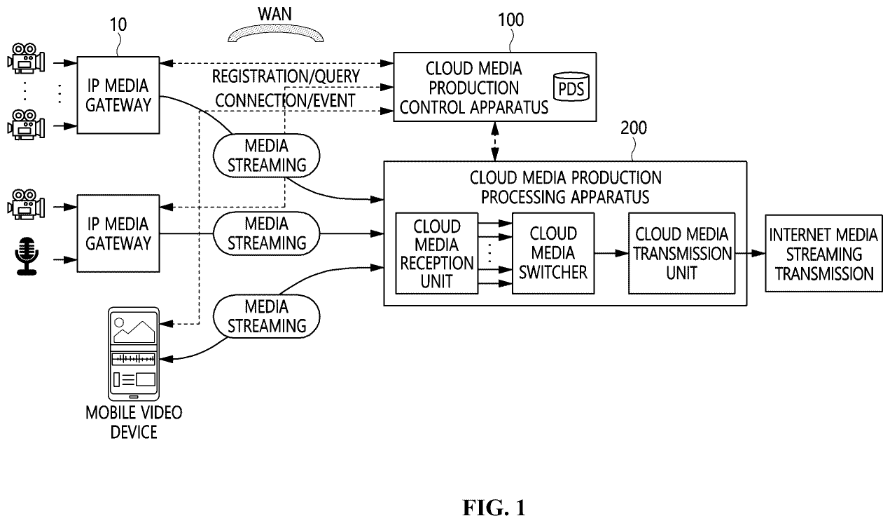

FIG. 1 is a diagram illustrating a cloud-IP media production platform according to an embodiment of the present disclosure.

Referring to FIG. 1, the cloud-IP media production platform may produce program video from videos that are input from pieces of remote broadcasting equipment through multiple channels in a cloud environment, and may transmit the program video through Internet media streaming. Media devices in a local environment may be connected to the cloud and become sources for media production, and require control and management of remote media devices so as to stream the video from the cloud in a wide-area environment. Therefore, various types of video devices used for production may be registered in a Registration and Discovery System (RDS) 20 of an apparatus 100 for controlling cloud media production (hereinafter also referred to as “cloud media production control apparatus 100”) either directly or through IP media gateways 10. Although the cloud media production control apparatus 100 may perform communication through direct connection in case that the RDS 20 is not present, the cloud media production control apparatus 100 may cache information about all nodes of the network at a central location when using the RDS 20.

The cloud-IP media production platform may include, for respective functions, the IP media gateways 10, the cloud media production control apparatus 100, and a cloud media production processing apparatus 200.

The IP media gateways 10 may receive camera input videos having various media data formats, such as Serial Digital Interface (SDI), a High-Definition Multimedia Interface (HDMI), Society of Motion Picture and Television Engineers (SMPTE) 2110, and a Network Device Interface (NDI), from remote sites, and may transfer the received videos to the cloud system through IP networks.

Here, each of the IP media gateways 10 may encapsulate input video using suitable compression and protocols.

Here, the IP media gateways 10 may transmit registration information about media devices connected thereto to the cloud media production control apparatus 100.

The cloud media production control apparatus 100 may control the flow of media transmitted to the cloud through the IP media gateways 10 by managing connections between devices.

The cloud media production control apparatus 100 may register devices for control and management of remote production devices required for media production, and may connect the devices of the system corresponding to registered media resources.

Here, the cloud media production control apparatus 100 may register and connect media devices of local sites connected through the IP media gateways 10 using a Networked Media Open Specifications (NMOS)-based access method.

Here, the cloud media production control apparatus 100 may register the registration information, including available resources and attributes of media devices that are used for production, in the registry of the cloud.

The registration information registered in the registry may include at least one of address translation information for actual data flow, or information related to a control data structure and a data flow (e.g., NMOS resource and Session Description Protocol (SDP) file) or a combination thereof.

The cloud media production processing apparatus 200 may include a cloud media reception unit, a cloud media switcher, and a cloud media transmission unit.

The cloud media reception unit may depacketize streams input from remote media devices, and may perform decoding on the depacketized streams.

The cloud media switcher may perform a function of monitoring various input videos, controlling remote access, and switching between preview videos and program videos.

The cloud media transmission unit may process streaming and recording for Internet media service interworking.

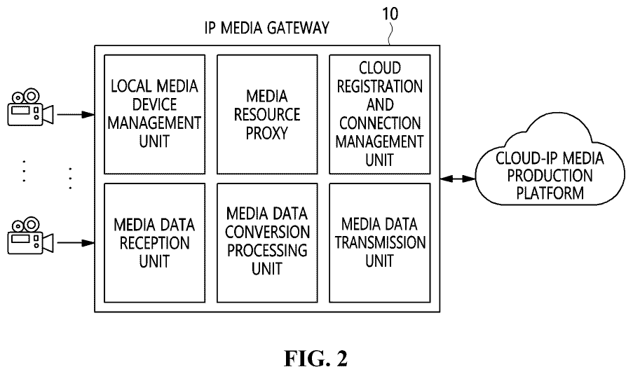

FIG. 2 is a diagram illustrating in detail an example of the IP media gateway illustrated in FIG. 1.

Referring to FIG. 2, the IP media gateway 10 may share subordinate resource sets of media devices in the cloud.

The functional configuration of the IP media gateway 10 may be divided into a control processing unit and a data processing unit.

The control processing unit of the IP media gateway 10 may include a local media device management unit, a media resource proxy, and a cloud registration and connection management unit.

The local media device management unit may perform functions such as discovery, registration, connection and control of media devices to be connected to a local network.

The registration and control of local network devices may follow the NMOS standard, or may follow other connection control standards.

The media resource proxy may store information about available resources of media devices connected to the local network.

The resource information may be information related to resources, such as sources, flows, and nodes, and may include a version, a label, description, format (audio, video, data, etc.), a transfer protocol, type, etc.

The cloud registration and connection management unit may reconstruct the resource information of the devices connected to the local network so as to be connected to the cloud-IP media production platform of the IP media gateway 10, and may then convert the reconstructed resource information into the resource information of the IP media gateway 10.

Here, the cloud registration and connection management unit may process a control procedure for registering and connecting the resource information in and to the cloud production platform.

Here, the cloud registration and connection management unit may optimize the connection between the IP media gateway and the cloud system depending on the Internet traffic.

Here, the cloud registration and connection management unit may provide notification of the resource capability of the IP media gateway 10 to transmit data in real time, and may establish a suitable transmission protocol for the connection between the IP media gateway 10 and the cloud media reception unit.

Further, the data processing unit of the IP media gateway 10 may include a media data reception unit, a media data conversion unit, and a media data transmission unit.

The media data reception unit may receive video data from media devices connected to the local network.

The media data conversion unit may convert the data input from the media devices into data having a suitable format so that the input data is transmitted to the wide-area network of the cloud production platform.

After the IP media gateway 10 is registered in the cloud, the media data transmission unit may transmit data to the corresponding node.

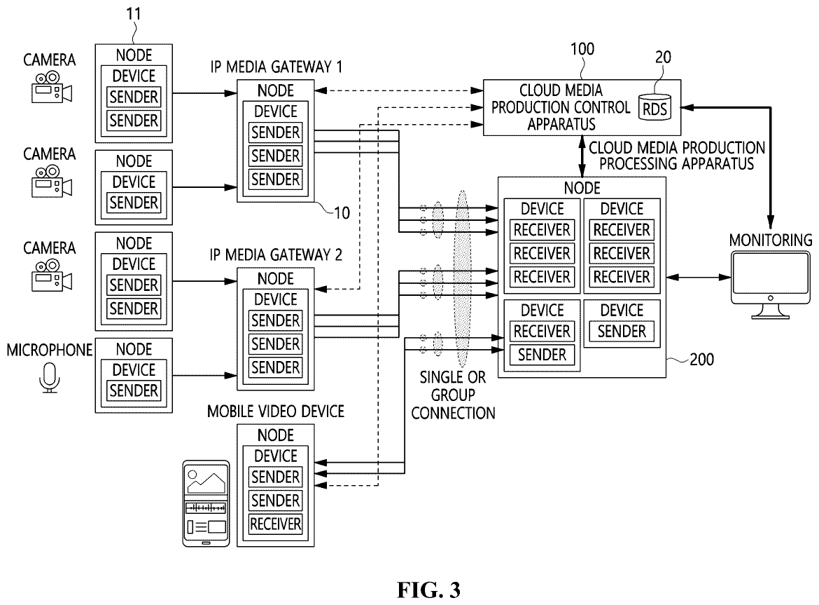

FIG. 3 is a block diagram illustrating a cloud media production system according to an embodiment of the present disclosure.

Referring to FIG. 3, the cloud media production system according to the embodiment of the present disclosure is illustrated. Each node 11 is a logical host connected to a network and the unit of communication between devices. One node includes logical units such as a device, a source, a flow, a sender, and a receiver, wherein the sender and the receiver are logical devices having an actual data transmission/reception function. For example, a camera may have one or more senders, and a microphone may also have one or more senders. Assuming that a camera has a return channel, the camera may have both a sender and a receiver. In an embodiment, assuming that a device connected to a camera having one sender and a camera having two senders is registered in the IP media gateway 10 connected to one or more media devices, the IP media gateway 10 may be a node including three senders.

In the case where a camera having two senders and a microphone having one sender are connected to and registered in the IP media gateway 10, the IP media gateway 10 may be a node having a total of three senders. A mobile video device may be a sender for transmitting captured video or may be a receiver for receiving data through the return channel.

The cloud media production processing apparatus 200 may receive and transmit video from a remote media device.

Here, the cloud media production processing apparatus 200 may select a program channel by switching video streams that are received through multiple channels, and may output the video stream in the selected program channel.

Here, the cloud media production processing apparatus 200 may be one of functional devices required for broadcast production, and may be any of logical host devices constituting a production network.

Here, the cloud media production processing apparatus 200 may configure one or more nodes as in the case of the IP media gateway 10.

The one or more nodes may include resources of various devices, senders, and receivers, and the resources may be registered, as components for media production, in the RDS 20 to perform a connection procedure.

Here, the cloud media production processing apparatus 200 may provide notification of capabilities as senders and receivers and transmission parameter information as senders so as to make connections to the senders or receivers, and may be connected to remote devices to process data transmission/reception.

Here, when the IP media gateway 10 connected over a wide area network is connected to the node of the cloud media production processing apparatus 200, the cloud cannot know cameras registered in the IP media gateway 10.

Here, the node of the cloud media production processing apparatus 200 may process data transmission/reception only for resources registered by the IP media gateway 10 or the mobile video device. That is, resources connected to a local network are not shared in the cloud.

The connection Application Programming Interface (API) of the NMOS may be a control interface for connection management between devices, and may be exposed between the devices registered in the RDS 20. The NMOS connection API may support a single connection interface for controlling a single device and a large-scale connection interface for controlling multiple senders/receivers. The large-scale connection interface may simultaneously prepare and activate parameters of multiple receivers in response to a single request. In the present disclosure, when the large-scale connection interface is processed, each flow may be processed such that the parameters are divided into groups based on classification criteria such as program IDs, studios, or regions at the time of setting parameters of multiple senders and receivers.

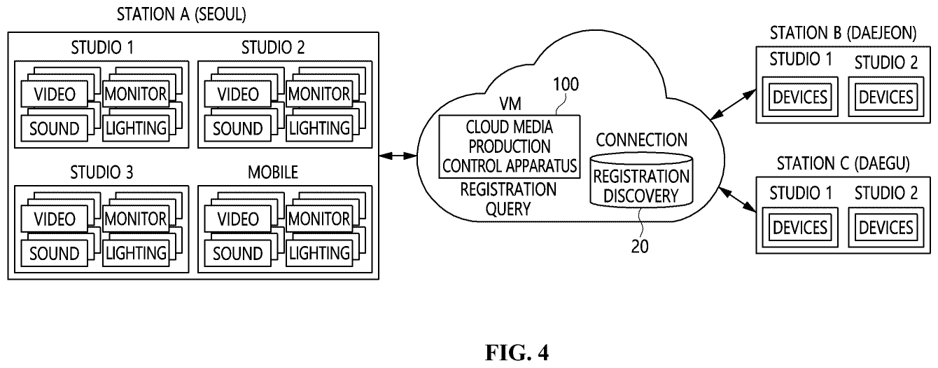

FIG. 4 is a diagram illustrating multiple devices registered in a cloud media production control apparatus according to an embodiment of the present disclosure.

Referring to FIG. 4, it can be seen that multiple devices for respective studios are registered in the RDS 20 of the cloud in a local station. There is the case where producing a single program occasionally requires the use and setup of dozens to hundreds of devices. There frequently occur the cases where production is performed through collaboration in workplaces in different stations or studio spaces. In this way, the cloud media production control apparatus 100 may efficiently classify and store pieces of registration information so that devices are registered, controlled and managed during a process of producing a program in the cloud through multiple devices distributed to the corresponding region.

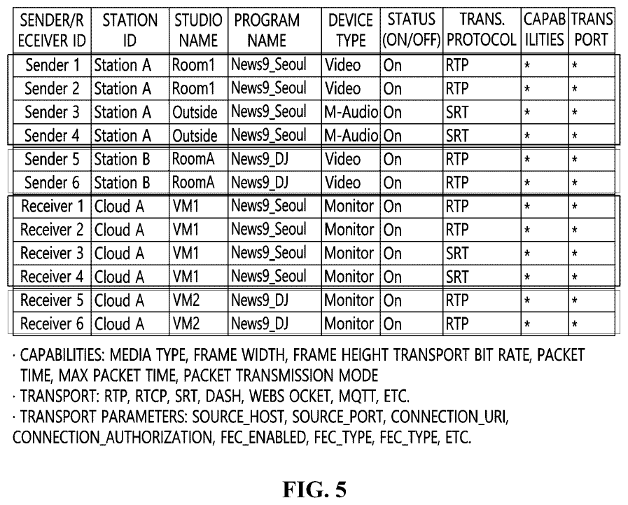

FIG. 5 is a diagram illustrating a method for storing information about registered resources according to an embodiment of the present disclosure.

Referring to FIG. 5, a method for storing information about registered resources required for controlling cloud media production is depicted.

The method for storing the information about the registered resources may specify a program name, a station ID, a studio name, an equipment type, or the like, which can be an establishment criterion that is common for devices. Resource change ranges and parameters may be set differently depending on the establishment criterion. Assuming that stations A (Seoul) and B (Daejeon) start producing the 9 o'clock news, the cloud media production control apparatus 100 may set simultaneous parameters for resource groups having the corresponding program IDs (e.g., News9_Seoul, News9_DJ) by using a group control interface.

Pseudocode 1 represents type definition for the group control interface.

[Pseudocode 1]

```
Objecttitle: ″Group sender/receiver resource″
Description: ″Describes a bulk group sender/receiver update resource″
$scheme: http://json-schema.org/draft-01/schema#
Type: ″array″
  Items:Object
  Type:″object″
    additionalProperties:false
    required:Array[2]
      0:″group_id″
      1: ″common_params″
    Properties:Object
      Id:Object
      Params:Object
```

Pseudocode 2 represents an example of use of the group control interface.

[Pseudocode 2]

```
Array[2]
0:Object
  group_id: ″News9_Seoul″
  common_params:Object
    master_enable:trup
    activation:Object
      mode: ″activate_scheduled_absolute″
      activation_time: ″2023-10-23T21:00:00″
    transport_params:Array[1]
      0:object
        rtcp_enabled:true
        rtp_enabled:true
        rtp_fec_enabled:true
        srt_mode: ″buffer″
        srt_fec_enabled:true
1:Object
  group_id: ″News9_DJ″
  common_params:Object
    master_enable:trup
    activation:Object
      mode: ″activate_scheduled_absolute″
      activation_time: ″2023-10-23T21:00:00″
    transport_params:Array[1]
      0:object
        rtcp_enabled:true
        rtp_enabled:true
        rtp_fec_enabled:true
```

Referring to Pseudocode 2, an example of use of a resource group control interface having program names (e.g., News9_Seoul, News9_DJ) corresponding to group control interface types is shown. It can be seen that, with respect to two news programs News9_Seoul and News9_DJ, parameters for simultaneous activation time and transmission of related devices are set.

The cloud media production control apparatus 100 may use commonly set parameters for all resources included in a reference group ID, rather than performing connection setup one by one for each of resources to be established through the group control interface. As an example of such parameter setting control, the cloud media production control apparatus 100 may set simultaneous activation time and transmission-related parameters through the group control interface. In particular, setting of simultaneous activation time and transmission-related parameters may be usefully used when transmission of large-capacity media is required in a variable bandwidth, when transmission setup needs to be changed to low-latency transmission setup, or when connection and transmission time points need to be determined.

group_id may be selected and used depending on the resource establishment range and the target based on Station ID, Studio Name, Program Name, or Device Type.

The cloud media production control apparatus 100 may facilitate large-scale connection management by supporting simultaneous connections and setup for respective groups (i.e., group-wise setup) of devices, and may easily provide work scalability and management by setting resource connections either individually or for respective work groups and enabling the change of settings.

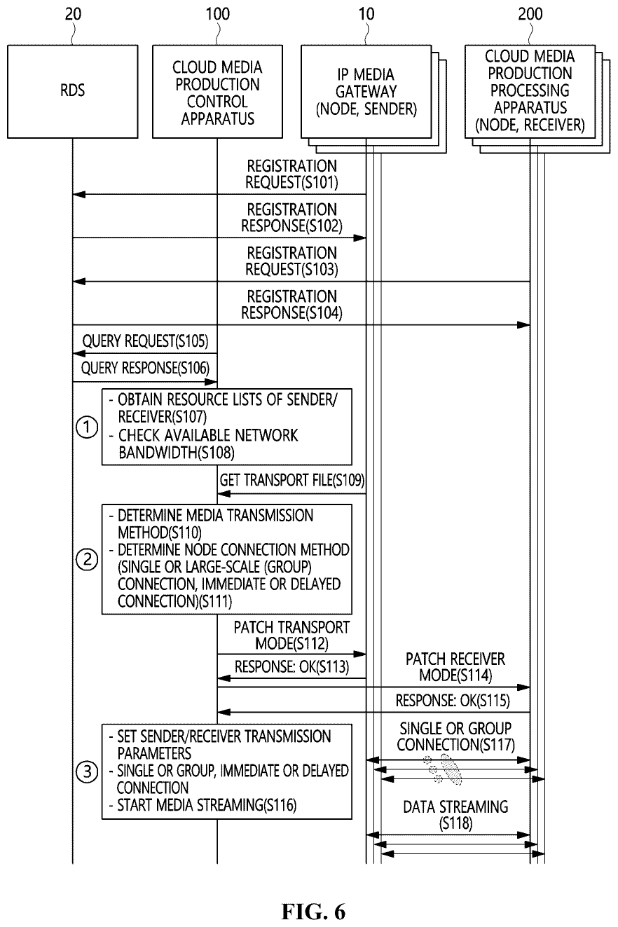

FIG. 6 is a sequence diagram illustrating a method for controlling cloud media production according to an embodiment of the present disclosure.

Referring to FIG. 6, a procedure is illustrated in which remote media devices are registered and connected to transmit media data to a cloud production platform in a system for controlling cloud media production.

First, an IP media gateway 10 may request an RDS 20 to register resources at step S101.

The RDS 20 may respond with the result of resource registration to the IP media gateway 10 at step S102.

The cloud media production processing apparatus 200 may request the RDS 20 to register resources at step S103.

The RDS 20 may respond with the result of resource registration to a cloud media production processing apparatus 200 at step S104.

The resource registration information may include the version of resources such as nodes, flows, and sources, the formats and attributes of the flow, such as audio, video, and data, sender/receiver capabilities, protocols used to transmit data over the network, etc.

The cloud media production control apparatus 100 may request resource registration information related to the production of a program from the RDS 20 in the form of a query at step S105.

The RDS 20 may respond with resource registration information related to program production to the cloud media production control apparatus 100 in the form of a query at step S106.

The cloud media production control apparatus 100 may obtain the resource registration information related to program production from the RDS 20 in the form of a query at step S107.

The cloud media production control apparatus 100 may check available network bandwidth for information analysis required for the connection between a sender and a receiver and for data transmission between the sender and the receiver based on the resource registration information obtained from the RDS 20 at step S108.

The cloud media production control apparatus 100 receives a transport file from the IP media gateway 10 and gets parameter information related to transmission by the sender from the IP media gateway 10 at step S109.

The cloud media production control apparatus 100 may determine setup parameters related to media transmission using information such as transmission parameter information of the sender, the capability of the receiver, a required bandwidth required for data transmission to connect a program production node, and a current available network bandwidth state at step S110.

The cloud media production control apparatus 100 may select a transmission buffer, video quality, and a transmission protocol within the capabilities and constraints of the sender/receiver depending on network status and waiting time at step S111.

Here, at step S111, the cloud media production control apparatus 100 may determine a node connection method depending on the network status, the network status of the sender and the receiver, nodes, and the current program production status.

The method for connecting the sender to the receiver may be a single connection or group connection, or an immediate or delayed connection.

Here, at step S111, the cloud media production control apparatus 100 may adjust individual transmission parameters of the receiver depending on the transport file received from the IP media gateway 10 and the receiver capability.

Here, at step S111, a simultaneous activation time and transmission parameters for at least two program-related devices and group-wise simultaneous connections between the devices may be set based on the available network bandwidth.

The group-based simultaneous connections may be performed by setting the group of the media sender and the media receiver based on the program name of the media, corresponding to the resource registration information, and the identifier of a station through which the media is to be transmitted.

Before connecting the sender to the receiver, the cloud media production control apparatus 100 may transmit a transport file, the parameter for basic connection of which is adjusted, to the IP media gateway 10 so as to determine whether the receiver is capable of processing the stream of a specific sender (i.e., patch a transport mode) at step S112.

The IP media gateway 10 may send a response, indicating whether the transport file, the parameter for basic connection of which is adjusted, has been received, to the cloud media production control apparatus 100 at step S113.

The cloud media production control apparatus 100 may transmit the transport file, the parameter of which is adjusted, to the cloud media production processing apparatus 200 (i.e., patch a receiver mode) at step S114.

The cloud media production processing apparatus 200 may send a response, indicating whether the transport file, the parameter of which is adjusted, has been received, to the cloud media production control apparatus 100 at step S115.

The cloud media production control apparatus 100 may start streaming in consideration of the response, indicating whether the transport file, the parameter of which is adjusted, has been received, from the media sender and the media receiver.

The IP media gateway 10 and the cloud media production processing apparatus 200 may perform a single or group connection at step S117.

The IP media gateway 10 and the cloud media production processing apparatus 200 may perform data streaming at step S118.

The registration and connection procedures according to the present disclosure are characterized in that real-time available network capacity is checked, and a transmission method for media video transferred in an utilizable network situation is determined and is set in the sender and the receiver. Furthermore, a single or group connection is possible depending on the policy of a media production operator.

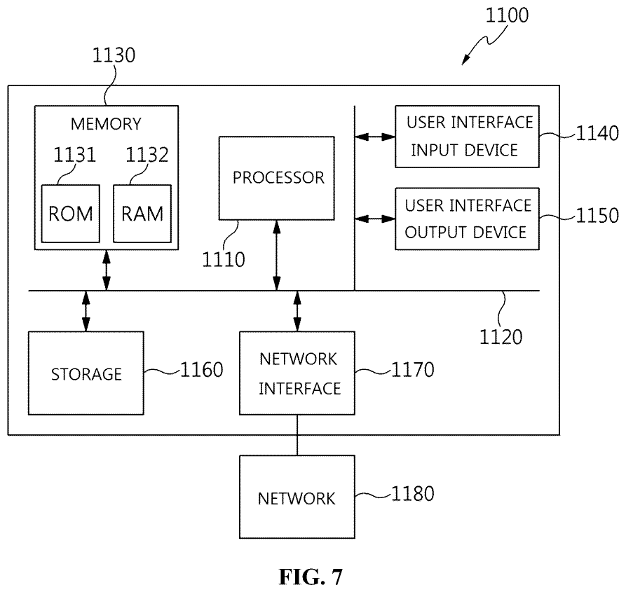

FIG. 7 is a diagram illustrating a computer system according to an embodiment of the present disclosure.

Referring to FIG. 7, each of a cloud media production control apparatus 100, a cloud media production processing apparatus 200, and an IP media gateway 10 may be implemented in a computer system 1100 such as a computer-readable storage medium. As shown in FIG. 7, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing programs or processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

A cloud media production control apparatus according to an embodiment of the present disclosure may include one or more processors 1110, and memory 1130 configured to store at least one program that is executed by the one or more processors 1110, wherein the at least one program is configured to check an available network bandwidth for data transmission based on resource registration information obtained from a Registration and Discovery System (RDS), receive a transport file from a media sender and obtain parameter information related to transmission by the media sender, adjust a transmission parameter of the transport file based on the resource registration information and the parameter information, transmit the transport file, the transmission parameter of which is adjusted, to the media sender and the media receiver, and start media streaming in consideration of a response to the transport file, the transmission parameter of which is adjusted, from the media sender and the media receiver.

Here, the resource registration information may include capabilities and network protocols of the media sender and the media receiver.

Here, the at least one program may be configured to determine parameters related to media transmission based on the capabilities of the media sender and the media receiver, a required bandwidth necessary for data transmission, and an available network bandwidth.

Here, the at least one program may be configured to select a transmission buffer, video quality, and a transmission protocol within the capabilities and constraints of the media sender and the media receiver depending on network status and waiting time.

Here, the at least one program may be configured to determine a node connection method depending on network status of the media sender and the media receiver.

Here, the at least one program may be configured to set up a simultaneous activation time and transmission parameters for devices related to at least two programs, and a group-wise simultaneous connection between the devices, based on the available network bandwidth.

Here, the group-wise simultaneous connection may be performed such that, based on a program name of media corresponding to the resource registration information and an identifier of a station through which the media is to be transmitted, groups of the media sender and the media receiver are set.

The present disclosure may register a remote media device and control the connection thereof in a wide-area network environment so as to produce cloud-IP-based high-quality media.

Further, the present disclosure may transfer data from devices having various formats of personal and professional Audio/Video (A/V) devices as well as transmitting large-capacity media, and provide interoperation with media having various interface formats.

Furthermore, the present disclosure may stably and efficiently transfer video data depending on variable network situations and resource states.

Furthermore, the present disclosure may efficiently operate management of large-scale connections and separately set up resource connections or set up resource connections either individually or for respective groups, thus facilitating work scalability and management.

As described above, in the apparatus and method for controlling cloud media production according to the present disclosure, the configurations and schemes in the above-described embodiments are not limitedly applied, and some or all of the above embodiments can be selectively combined and configured so that various modifications are possible.

What is claimed is:

1. An apparatus for controlling cloud media production, comprising:
one or more processors; and
a memory configured to store at least one program that is executed by the one or more processors, wherein the at least one program is configured to:
check an available network bandwidth for data transmission based on resource registration information obtained from a Registration and Discovery System (RDS),
receive a transport file from a media sender and obtain parameter information related to transmission by the media sender,
adjust a transmission parameter of the transport file based on the resource registration information and the parameter information,
transmit the transport file, the transmission parameter of which is adjusted, to the media sender and the media receiver, and
start media streaming in consideration of a response to the transport file, the transmission parameter of which is adjusted, from the media sender and the media receiver.

2. The apparatus of claim 1, wherein the resource registration information includes capabilities and network protocols of the media sender and the media receiver.

3. The apparatus of claim 2, wherein the at least one program is configured to determine parameters related to media transmission based on the capabilities of the media sender and the media receiver, a required bandwidth necessary for data transmission, and an available network bandwidth.

4. The apparatus of claim 3, wherein the at least one program is configured to select a transmission buffer, video quality, and a transmission protocol within the capabilities and constraints of the media sender and the media receiver depending on network status and waiting time.

5. The apparatus of claim 3, wherein the at least one program is configured to determine a node connection method depending on network status of the media sender and the media receiver.

6. The apparatus of claim 5, wherein the at least one program is configured to set up a simultaneous activation time and transmission parameters for devices related to at least two programs, and a group-wise simultaneous connection between the devices, based on the available network bandwidth.

7. The apparatus of claim 6, wherein the group-wise simultaneous connection is performed such that, based on a program name of media corresponding to the resource registration information and an identifier of a station through which the media is to be transmitted, groups of the media sender and the media receiver are set.

8. A method for controlling cloud media production, the method being performed by an apparatus for controlling cloud media production, the method comprising:
checking an available network bandwidth for data transmission based on resource registration information obtained from a Registration and Discovery System (RDS);
receiving a transport file from a media sender and obtain parameter information related to transmission by the media sender;
adjusting a transmission parameter of the transport file based on the resource registration information and the parameter information;
transmitting the transport file, the transmission parameter of which is adjusted, to the media sender and the media receiver; and
starting media streaming in consideration of a response to the transport file, the transmission parameter of which is adjusted, from the media sender and the media receiver.

9. The method of claim 8, wherein the resource registration information includes capabilities and network protocols of the media sender and the media receiver.

10. The method of claim 9, wherein adjusting the transmission parameter comprises:
determining parameters related to media transmission based on the capabilities of the media sender and the media receiver, a required bandwidth necessary for data transmission, and an available network bandwidth.

11. The method of claim 10, wherein adjusting the transmission parameter further comprises:
selecting a transmission buffer, a video quality, and a transmission protocol within the capabilities and constraints of the media sender and the media receiver depending on network status and waiting time.

12. The method of claim 10, wherein adjusting the transmission parameter further comprises:
determining a node connection method depending on network status of the media sender and the media receiver.

13. The method of claim 12, wherein adjusting the transmission parameter further comprises:
setting up a simultaneous activation time and transmission parameters for devices related to at least two programs, and a group-wise simultaneous connection between the devices, based on the available network bandwidth.

14. The method of claim 13, wherein the group-wise simultaneous connection is performed such that, based on a program name of media corresponding to the resource registration information and an identifier of a station through which the media is to be transmitted, groups of the media sender and the media receiver are set.
